(19) United States
(12) Patent Application Publication
(10) Pub. No.: US 2010/0115994 A1
(43) Pub. Date: May 13, 2010

(54) ADSORBENT FOR CARBON MONOXIDE, GAS PURIFICATION METHOD, AND GAS PURIFICATION APPARATUS

(76) Inventors: Masayoshi Hayashida, Hokuto-shi (JP); Akihiro Nakamura, Kofu-shi (JP); Tatsuya Hidano, Kai-shi (JP); Kazuhiko Fujie, Nirasaki-shi (JP); Masato Kawai, Yokohama-shi (JP)

Correspondence Address: NIXON & VANDERHYE, PC, 901 NORTH GLEBE ROAD, 11TH FLOOR, ARLINGTON, VA, 22203, US

(21) Appl. No.: 12/529,764

(22) PCT Filed: Mar. 4, 2008
(86) PCT No.: PCT/JP2008/053817

§ 371 Date: Sep. 3, 2009

(30) Foreign Application Priority Data
Mar. 5, 2007 (JP) 2007-054647

(51) Int. Cl. F25J 3/00; B01J 29/46; B01D 53/02

(52) U.S. Cl. 62/640; 502/77; 95/140; 96/146

(57) ABSTRACT

The adsorbent for carbon monoxide of the present invention is obtained by activating a Cu-ZSM5 type zeolite prepared as a catalyst for removal of NO_{X} through heating at 450 to 600° C. in an inert gas atmosphere containing no moisture. The gas purification method of the present invention includes removing carbon monoxide as a trace amount of impurities contained in a gas by a temperature swing adsorption method, wherein the adsorbent for carbon monoxide according to claim 1 is used, and a regeneration operation of the adsorbent for carbon monoxide is carried out at 200 to 350° C.

### TECHNICAL FIELD

The present invention relates to an adsorbent used to further purify an inert gas containing rare gases such as high-purity nitrogen, argon, helium, neon, krypton, xenon and the like, and a gas purification method and a gas purification apparatus each using the same, which particularly makes it possible to give an ultrahigh-purity gas by efficiently removing a trace amount of carbon monoxide contained in these gases.

This application claims priority on Japanese Patent Application No. 2007-054647 filed on Mar. 5, 2007, the disclosure of which is incorporated by reference herein.

### BACKGROUND ART

As a method for mass-producing oxygen, nitrogen, argon or the like, a cryogenic air separation unit has widely been used.

According to the cryogenic air separation unit, feed air is liquefied by cooling to a very low temperature, and components of the air is separated into oxygen, nitrogen, argon or the like by distillation. It is known that about 0.1 ppm of carbon monoxide exists in atmospheric air. If a special removal means is not used, carbon monoxide in feed air taken into the cryogenic air separation unit is concentrated at a gas phase side in a distillation column, and thus is included in product nitrogen or crude argon.

In the case of the use of a gas for general industry, no problem arises even if nitrogen or argon contains a trace amount of carbon monoxide. However, some applications require ultrahigh purity for nitrogen which is used for semiconductor industry. In such a case, it is necessary to remove even a trace amount of carbon monoxide.

With recent intensification of air pollution, the concentration of carbon monoxide contained in atmospheric air tends to increase, and also the concentration of carbon monoxide contained in nitrogen or crude argon obtained from the cryogenic air separation unit also tends to increase. Therefore, necessity for removal of carbon monoxide in these gases has increased.

U.S. Pat. No. 5,551,257 (Patent Document 1) discloses removal of carbon monoxide by adsorption under very low temperature conditions using CaX, CaA and NaX zeolite adsorbents.

Also, Separation & Purification Technology (Non-Patent Document 1) discloses removal of carbon monoxide under very low temperature conditions using a porous metal oxide such as hopcalite.

Japanese Unexamined Patent Application, First Publication No. Sho 60-156548 (Patent Document 2) discloses, as an adsorbent for carbon monoxide, a Cu-ZSM5 type zeolite in which a silica/alumina ratio (SiO₂/Al₂O₃) is 19 or less.

Japanese Unexamined Patent Application, First Publication No. 2003-311148 (Patent Document 3) discloses a Cu-ZSM5 type zeolite as an adsorbent which can be used for removal of carbon monoxide at normal temperature.

The method for removal by adsorption at a very low temperature disclosed in Patent Document 1 had a problem that the equipment for maintaining the very low temperature is complicated, resulting in high cost.

The adsorbent disclosed in Patent Document 2 has high carbon monoxide adsorption ability, but had a problem that it is necessary to carry out a heat treatment in a CO atmosphere since a special ZSM5 type zeolite having a silica/alumina ratio of 19 or less is used.

The adsorbent disclosed in Patent Document 3 has high carbon monoxide adsorption ability, but a heat treatment at a high temperature of 700° C. is required as a pretreatment of an adsorbent. When the temperature exceeds 350° C. in a plant such as a cryogenic air separation unit, expensive heat-resistant components must be used for a valve or the like, and therefore there remains a problem in practicability.

A commercially available Cu-ZSM5 type zeolite is produced so as to be used as a catalyst for removal of NO_{X}. It is presumed that the Cu-ZSM5 type zeolite used as a catalyst is subjected to a treatment which is different from that in the case of a production step of the adsorbent, and adsorption ability of carbon monoxide is considered to be insufficient. Although the Cu-ZSM5 type zeolite can be produced for carbon monoxide adsorption from the beginning, there is a problem that the cost of the adsorbent considerably increases since applications are limited.

[Patent Document 1]

U.S. Pat. No. 5,551,257

[Patent Document 2]

Japanese Unexamined Patent Application, First Publication No. Sho 60-156548

[Patent Document 3]

Japanese Unexamined Patent Application, First Publication No. 2003-311148

[Non-Patent Document 1]

Separation and Purification Technology, Vol. 11, 47-56 (1997)

### DISCLOSURE OF THE INVENTION

### Problems to be Solved by the Invention

Under these circumstances, the present invention retreats a Cu-ZSM5 type zeolite produced as a commercially available catalyst for removal of NO_{X}, to thereby provide an adsorbent for carbon monoxide that is inexpensive and has high adsorption ability, and a gas purification method and a gas purification apparatus each using the same.

### Means for Solving the Problems

The adsorbent for carbon monoxide of the present invention is obtained by activating a Cu-ZSM5 type zeolite prepared as a catalyst for removal of NO_{X} through heating at 450 to 600° C. in an inert gas atmosphere containing no moisture.

The gas purification method of the present invention includes removing carbon monoxide as a trace amount of an impurity contained in a gas by a temperature swing adsorption method using the adsorbent for carbon monoxide of the present invention, wherein a regeneration operation of the adsorbent for carbon monoxide is carried out at 200 to 350° C.

In the gas purification method of the present invention, the gas to be purified can be high-purity nitrogen, argon, helium, neon, krypton or xenon.

The gas purification apparatus of the present invention includes an adsorption column filled with the adsorbents for carbon monoxide of the present invention, and a heating device for heat regeneration of the adsorbents filled in the adsorption column at 200 to 350° C., wherein a gas is purified by a temperature swing adsorption method. Specifically, carbon monoxide as a trace amount of an impurity in the gas is removed by a temperature swing adsorption method. The heating device preferably heats a gas to be regenerated.

The cryogenic air separation unit of the present invention includes the gas purification apparatus described above.

The term “Cu-ZSM5 type zeolite” in the present invention means a so-called ZSM5 type zeolite which contains copper as a cation.

The expression “prepared as a catalyst for removal of NO_{X}” in the present invention means that it is prepared for a catalytic cracking catalyst of nitrogen oxide.

For example, as disclosed in Japanese Unexamined Patent Application, First Publication No. Sho 60-125250, a ZSM5 type zeolite is immersed in an aqueous solution containing a mineral salt such as copper sulfate, copper nitrate or the like, or an organic acid salt such as copper acetate or the like dissolved therein, and cations are ion-exchanged with copper ions. Furthermore, the ZSM5 type zeolite impregnated with the aqueous solution is dried and then subjected to a heat treatment in air or nitrogen to obtain a product.

As disclosed in Japanese Unexamined Patent Application, First Publication No. Hei 3-65242, a Cu-ZSM5 type zeolite can be used, which is obtained by a method in which an inert gas containing hydrogen added therein is allowed to flow at 600° C. upon a heat treatment.

Furthermore, as disclosed in Japanese Unexamined Patent Application, First Publication No. Hei 4-193710, a zeolite can be used, which is obtained by calcining it at 500 to 900° C. while allowing air having a moisture content of 5,000 ppm or less to flow at SV (Space Velocity) of 400 hr⁻¹ or more. In any case, a Cu-ZSM5 type zeolite is prepared so as to have an ability suited for a catalytic cracking catalyst of nitrogen oxide.

Regarding the Cu-ZSM5 type zeolite for a catalytic cracking catalyst of nitrogen oxide, prior art documents disclose that the silica/alumina ratio (SiO₂/Al₂O₃) is a value ranging widely from 10 to 2,000. For example, the silica/alumina ratio is as follows: Japanese Unexamined Patent Application, First Publication No. Sho 60-125250 (SiO₂/Al₂O₃=20 to 100), Japanese Unexamined Patent Application, First Publication No. Hei 3-65242 (SiO₂/Al₂O₃=10 to 2000), Japanese Unexamined Patent Application, First Publication No. Hei 3-131344 (SiO₂/Al₂O₃=100 to 350), and Japanese Unexamined Patent Application, First Publication No. Hei 9-122494 (SiO₂/Al₂O₃=10 to 500).

In the Cu-ZSM5 type zeolite used as the adsorbent for carbon monoxide of the present invention, the amount of ion-exchangeable copper ions is preferably as much as possible. Since the number of ion exchange sites of the zeolite is in proportion to the amount of Al₂O₃ contained therein, the amount of Al₂O₃ is preferably as much as possible so as to increase an ion exchange quantity. Therefore, it is preferred that SiO₂/Al₂O₃ is a comparatively small value. In contrast, since a decrease in SiO₂/Al₂O₃ leads to an increase in production cost, a proper range is settled. Specifically, it is preferably from 20 to 50.

Japanese Unexamined Patent Application, First Publication No. Sho 60-125250 describes that a copper ion exchange ratio of the Cu-ZSM5 type zeolite is at least 10%, and preferably 40 to 100% in the case of the catalytic cracking catalyst of nitrogen oxide.

However, Japanese Unexamined Patent Application, First Publication No. Hei 3-131344 describes supporting of 5 to 30% by weight, while Japanese Unexamined Patent Application, First Publication No. Hei 9-122494 describes that the upper limit is specified to 200% for Cu⁺ or 100% for Cu²⁺, and also there are some cases that the content is not specified.

In general, it becomes necessary to repeatedly carry out ion exchange operation so as to obtain a high ion exchange ratio in ion exchange of zeolite, and thus a proper exchange ratio is determined by good balance between production cost and catalytic activity. Taking account of economical efficiency in industrial production, when calculation is performed under the assumption that a copper ion is divalent (Cu²⁺), it is considered that an exchange ratio of the copper ion prepared as a commercially available catalyst for removal of NO_{X} is from 100 to 150%.

However, since the adsorbent for carbon monoxide of the present invention preferably has a higher copper ion exchange ratio, those having an ion exchange ratio of 150% or more may also be used.

The “inert gas atmosphere containing no moisture” in the present invention may be a vacuum atmosphere, or may be formed by allowing an inert gas such as dry nitrogen to flow at a proper flow rate. Although a rare gas such as helium, neon, argon, krypton, xenon or the like can be used as the inert gas, nitrogen or argon is preferably used from an economical point of view.

Regarding the adsorbent for carbon monoxide of the present invention, an adsorbent capable of adsorbing a large amount of carbon monoxide can be obtained by heating a Cu-ZSM5 type zeolite prepared as a catalyst for removal of NO_{X} in an atmosphere containing no moisture at a temperature of 450 to 600° C., preferably 480 to 570° C., and more preferably 500 to 550° C. When the temperature is lower than 450° C., no effect of activation is exerted. When the temperature exceeds 600° C., performances begin to deteriorate. When the temperature is 600° C. or higher, economical demerits increase, for example, it becomes necessary to use a special heater as a heat source.

A method for subjecting Cu-ZSM5 type zeolite to an activation treatment is carried out in an inert gas atmosphere in which dry nitrogen is allow to flow so as to obtain the adsorbent for carbon monoxide of the present invention. Therefore, after filling an adsorption column of the gas purification apparatus of the present invention with a Cu-ZSM5 type zeolite prepared as a catalyst for removal of NO_{X}, heating may also be carried out while allowing an inert gas containing no moisture, such as dry nitrogen, heated at a temperature of 450 to 600° C. to flow using a heating device other than a heating device for adsorbent regeneration.

The gas purification method of the present invention removes a trace amount of carbon monoxide in a high-purity gas through a temperature swing adsorption operation using the adsorbent for carbon monoxide of the present invention. If the adsorbent is heated at a temperature of 450 to 600° C. before filling an adsorption column of the gas purification apparatus of the present invention with an adsorbent, it is not necessarily required to regenerate the adsorbent at this temperature in a TSA operation. For example, high carbon monoxide adsorption performance can be maintained even if regeneration is carried out at a temperature of 200 to 350° C.

### EFFECTS OF THE INVENTION

According to the present invention, it is possible to obtain an adsorbent capable of adsorbing a trace amount of carbon monoxide contained in a gas by subjecting a commercially available Cu-ZSM5 type zeolite prepared as a catalyst for removal of NO_{X} to a heat treatment in an inert gas atmosphere containing no moisture. Use of this adsorbent enables gas purification which converts a high-purity gas into an ultrahigh-purity gas.

### BRIEF DESCRIPTION OF THE DRAWINGS

FIG. 1 is a schematic block diagram showing one example of a gas purification apparatus of the present invention.

FIG. 2 is a graph showing an adsorption isotherm which exhibits an influence of activation on an adsorption amount of carbon monoxide.

FIG. 3 is a graph showing a relation between the activation temperature and the adsorption amount of carbon monoxide.

FIG. 4 is a graph showing an influence of a regeneration temperature on an adsorption amount of carbon monoxide.

FIG. 5 is a graph showing a breakthrough curve of carbon monoxide in nitrogen containing a trace amount of carbon monoxide.

FIG. 6 is a graph showing a breakthrough curve of carbon monoxide in argon containing a trace amount of carbon monoxide.

FIG. 7 is a graph showing a breakthrough curve of carbon monoxide in nitrogen containing a trace amount of carbon monoxide when a Cu-ZSM5 type zeolite initially activated by nitrogen containing water is used.

### DESCRIPTION OF REFERENCE SYMBOLS

10a (10b): Adsorption column

### BEST MODE FOR CARRYING OUT THE INVENTION

Embodiments of the present invention will be explained in detail below.

One example of a method for preparing an adsorbent for carbon monoxide in the present invention will be shown below.

A column made of metal is filled with a pelletized Cu-ZSM5 type zeolite prepared as a catalyst for removal of NO_{X}, and nitrogen heated to 550° C. is allowed to flow through the column at 1 m³/h for 3 hours, thereby activating the Cu-ZSM5 type zeolite. An reached temperature of the Cu-ZSM5 type zeolite is about 500° C.

The adsorbent for carbon monoxide of the present invention can be obtained by such an activation treatment.

As the pelletized Cu-ZSM5 type zeolite prepared as a catalyst for removal of NO_{X}, a commercially available zeolite can also be used and can be provided at low cost, but there is no limitation.

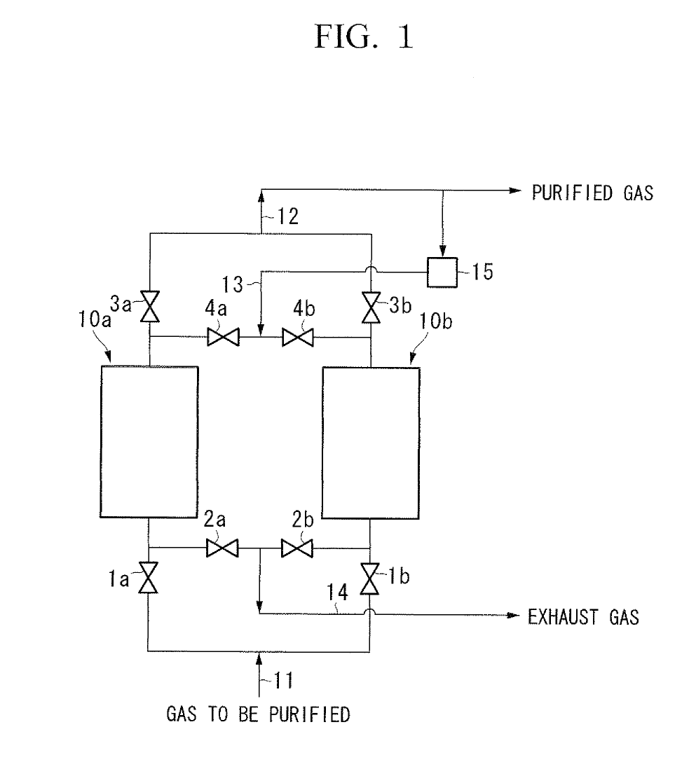

The activated Cu-ZSM5 type zeolite can be used for purification of a gas by a temperature swing adsorption method after filling it in an adsorption column of a gas purification apparatus as shown in FIG. 1.

The present embodiment shows an example in which a trace amount of carbon monoxide contained in nitrogen is removed, and two adsorption columns 10a, 10b are filled with the adsorbent for carbon monoxide of the present invention, and also an adsorption process and a regeneration process in each adsorption column are carried out by the steps shown in Table 1. A regeneration process includes four steps of depressurization, heat regeneration, cooling and repressurization.

TABLE 1

| Adsorption | Adsorption process | Regeneration process | | | |
|---|---|---|---|---|---|
| column 10a | Adsorption | Depres- | Heat | Cooling | Repres- |
| | | surizatioin | regeneration | | surization |

| Adsorption | Regeneration process | | | | Adsorption process |
|---|---|---|---|---|---|
| column 10b | Depres- | Heat | Cooling | Repres- | Adsorption |
| | surizatioin | Regeneration | | surization | |

An operation example of a gas purification apparatus based on Table 1 will be shown below.

In FIG. 1, an adsorption column 10a is assumed to perform an adsorption process, and an adsorption column 10h is assumed to perform a regeneration process.

Valves 1b, 2a, 3b and 4a are closed. Nitrogen containing a trace amount of carbon monoxide is introduced into the adsorption column 10a through a line 11 via a valve 1a. The introduced nitrogen is supplied to a destination as purified nitrogen through a line 12 via a valve 3a after removing carbon monoxide in the adsorption column 10a.

Carbon monoxide in nitrogen as a feed gas is adsorbed on an adsorbent in the vicinity of a gas inlet of the adsorption column 10a in an initial stage of the adsorption process, and an adsorption zone of carbon monoxide gradually proceeds toward a gas outlet of the adsorption column 10a with the lapse of an adsorption process time. When the adsorption process is continued, carbon monoxide is finally detected at the outlet of the adsorption column 10a (so-called breakthrough state).

When it is not preferred that the purified gas contains even an ultra trace amount of carbon monoxide, the adsorption process is completed by closing valves 1a and 3a before breakthrough. When it is accepted to contain an ultra trace amount of carbon monoxide, the adsorption process time can be prolonged within an acceptable range.

While the adsorption process is carried out in the adsorption column 10a, a regeneration process is carried out in the adsorption column 10b. After completion of the adsorption process in the adsorption column 10b, valves 1b, 2b, 3b and 4b are closed. After entering into the regeneration process in the adsorption column 10b, when the adsorption process is carried out under pressure, first, a valve 2b is opened and inside of the adsorption column 10b is depressurized to an atmospheric pressure by atmospheric release through a line 14 (depressurization step).

Next, a portion of the purified gas is introduced into a heater 15 through a line 12, followed by heating to 200° C., opening of a valve 4b, and further introduction of a heat regenerated gas into the adsorption column 10b, and thus heat regeneration of a adsorbent for carbon monoxide is carried out (heat regeneration step). Carbon monoxide is desorbed by heating and discharged as an exhaust gas through the line 14, together with the heat regenerated gas. When the temperature of the exhaust gas to be discharged through a valve 2b reached around a predetermined temperature, for example, around 200° C., the heat regeneration step is terminated (the heater 15 is turned off). The regeneration temperature of the adsorbent is controlled within a range from 200 to 350° C., preferably from 250 to 350° C., and more preferably from 300 to 350° C. When the regeneration temperature is lower than 200° C., the absorbent is insufficiently regenerated. In contrast, when the regeneration temperature exceeds 350° C., economical demerits occur, for example, it is necessary to use a special material having carefully considered heat resistance for pipes and valves.

When the heat regeneration step is completed, the adsorbent is subjected to a cooling step. The cooling step aims at enhancing adsorption ability by equalizing the temperature of the adsorbent with that of the gas to be purified. A portion of the purified gas is introduced into the adsorption column 10b through a line 13 via a valve 4b without being heated and then discharged out of the system through the line 14 via a valve 2b. When the temperature of the gas to be discharged becomes almost the same as that of the gas to be purified, the cooling step is terminated.

After completion of the cooling step, repressurization is carried out (repressurization step). The prepressurization step aims at preventing the gas to be purified from flowing into the adsorption column at a high flow rate in the time of being switched to the adsorption process, and carbon monoxide from blowing off through without adsorption, by making the pressure in the adsorption column close to the pressure of the gas to be purified.

In the repressurization step, the valve 2b is closed and a portion of the purified gas is continuously supplied through the valve 4, and then the pressure in the adsorption column 10b is increased to around the pressure in the adsorption process. When the regeneration process of the adsorption column 10b by four steps described above is completed, valves 1b, 2b, 3b and 4b are closed and the process waits until the adsorption process of adsorption column 10a is completed.

When the adsorption process of the adsorption column 10a is completed, the step of adsorption column 10a is switched to a regeneration process, while the step of the adsorption column 10b is switched to an adsorption process. Next, carbon monoxide can be continuously removed from nitrogen by alternately carrying out the adsorption and regeneration processes in two adsorption columns.

The gas purification method using the gas purification apparatus can also be applied for purification of nitrogen obtained by a cryogenic air separation method. The cryogenic air separation method is a method of separating feed air, from which water and carbon dioxide have been removed, into nitrogen, oxygen and argon through partial liquefaction and distillation.

It is difficult to separate carbon monoxide from nitrogen by distillation since carbon monoxide has physical properties similar to those of nitrogen. Therefore, if carbon monoxide is not removed at a stage of a pretreatment of removing water and carbon dioxide from the feed air, almost all of the carbon monoxide is concentrated in product nitrogen.

Therefore, if a cryogenic air separation unit is provided with the gas purification apparatus of the present invention, carbon monoxide can be removed from the product nitrogen. If carbon monoxide in the feed air is preliminarily removed by the gas purification apparatus of the present invention, carbon monoxide is not concentrated in the product nitrogen.

It is also possible to fill a column of pre-purification unit for removing water and carbon dioxide with the adsorbent for carbon monoxide of the present invention. If the column of pre-purification unit is filled with the adsorbent for carbon monoxide to provide a gas purification apparatus, the adsorption column for removal of carbon monoxide can be omitted. Alternatively, it is also possible to provide a cryogenic air separation unit in which the gas purification apparatus of the present invention is disposed at a down stream side of the distillation column.

If the gas purification apparatus of the present invention is disposed at a down stream side of the distillation column, the amount of the gas to be purified is reduced to half compared with the case of preliminarily removing carbon monoxide from feed air, and thus the size of the gas purification apparatus can be reduced. When there is no need to purify the entire amount of the product nitrogen, a gas purification apparatus having a capacity set in accordance with the necessary amount may be used and thus the size of the apparatus can be further reduced. The same is applied for the case of purification of product argon.

While removal of a trace amount of carbon monoxide contained in nitrogen was mainly mentioned in the present embodiment, the adsorbent for carbon monoxide of the present invention does not cause blocking of adsorption of carbon monoxide due to an inert gas, and therefore can be applied for purification by removing carbon monoxide in not only nitrogen, but also rare gases such as helium, neon, argon, krypton, xenon and the like.

### EXAMPLES

Specific examples will be described below.

### Example 1

A column made of metal, measuring 50.8 mm in diameter and 0.8 m in length was filled with Cu-ZSM5 type zeolite (SiO₂/Al₂O₃=30 to 50, Cu ion exchange ratio: 100 to 130% (assumed to be ion-exchanged in terms of Cu²⁺), diameter: 1 mm, length: 3 to 5 mm) as a commercially available pelletized catalyst for removal of NO_{X}, and then the zeolite was activated by heating it at 500° C. while allowing nitrogen at 550° C. to flow at a rate of 1 m³/h for 3 hours to obtain an adsorbent for carbon monoxide of the present invention.

A column made of metal, measuring 17.4 mm in inner diameter was filled with the obtained adsorbent in height of 0.2 m and carbon monoxide was sufficiently adsorbed by allowing nitrogen containing 1 ppm of carbon monoxide at 25° C. to flow at a rate of 20 L/min, and then heat regeneration of the adsorbent was carried out for 2 hours while evacuating at 200° C. The heat regeneration at 200° C. is carried out assuming that the absorbent is regenerated at around 200° C. when a gas is purified by a temperature swing adsorption method.

An equilibrium adsorption amount of carbon monoxide of a heat-regenerated Cu-ZSM5 type zeolite was measured using BELSORP 28 (manufactured by BEL Japan, Inc.).

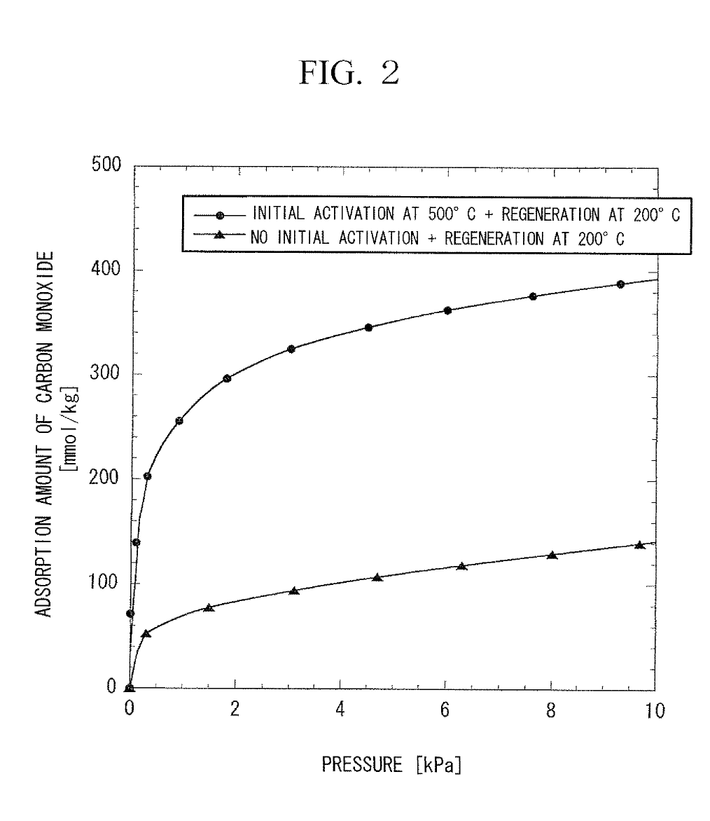

An adsorption isotherm of carbon monoxide at 25° C. is shown in FIG. 2.

For comparison, an adsorption isotherm was measured in the case of a Cu-ZSM5 type zeolite which was not subjected to an activation treatment. The Cu-ZSM5 type zeolite used for comparison was also subjected to heat regeneration for 2 hours while evacuating at 200° C. after sufficiently adsorbing carbon monoxide while allowing nitrogen containing 1 ppm of carbon monoxide at 25° C. to flow at a rate of 20 L/min.

As is apparent from the adsorption isotherm shown in FIG. 2, the adsorbent subjected to an activation treatment at 500° C. shows an adsorption amount 3 or more times larger than that of the adsorbent subjected to no activation treatment, at an adsorption pressure of 0.5 kPa, and thus adsorption performance is remarkably improved.

As described above, if the Cu-ZSM5 type zeolite as a commercially available catalyst for removal of NO_{X} is once activated by a heat treatment, an improvement of adsorption performance is recognized even when regenerated at a low temperature.

### Example 2

An influence of the Cu-ZSM5 type zeolite on adsorption performance of carbon monoxide in terms of the activation treatment temperature is shown below.

In the same manner as in Example 1, except that the treating temperature was changed, a commercially available Cu-ZSM5 type zeolite as a catalyst for removal of NO_{X} was activated. The treating temperature was set at 300° C., 350° C., 400° C., 450° C., 500° C. and 600° C. to obtain six kinds of adsorbents for carbon monoxide.

The adsorption amount of carbon monoxide at 25° C. of these adsorbents was measured by a volumetric adsorption measuring apparatus. Each adsorbent (1 g) was filled in the measuring apparatus and, assuming the case when used for purification of product nitrogen obtained from the cryogenic air separation unit, an absorption/desorption operation of heat-regenerating at 300° C. after allowing nitrogen containing 5 ppm of carbon monoxide to flow was carried out once and then an adsorption isotherm was measured.

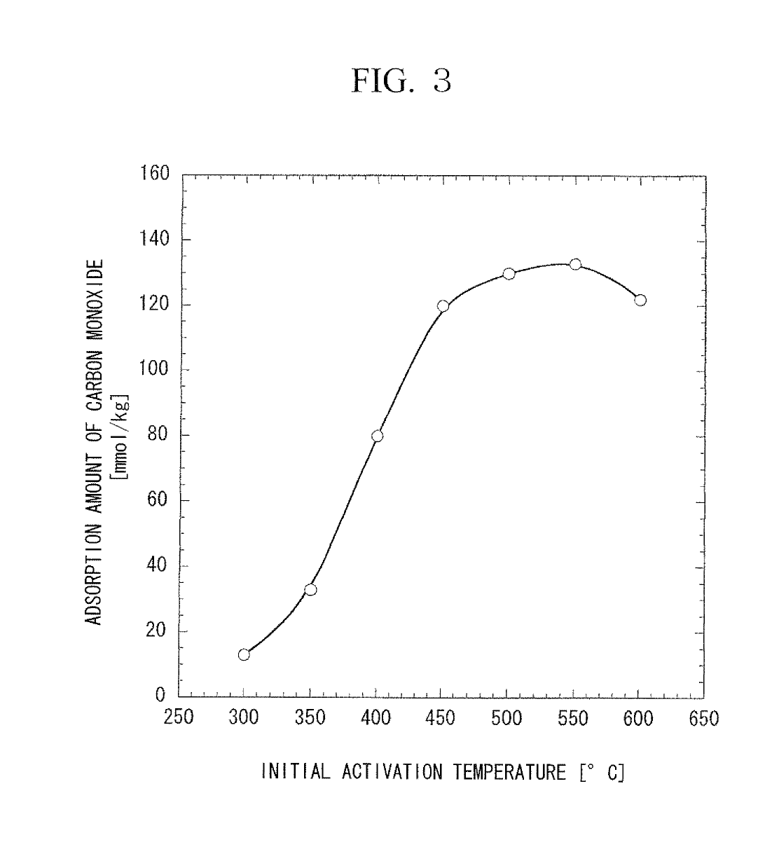

The adsorption amount of carbon monoxide under a pressure of 3 Pa was determined from the adsorption isotherm of each adsorbent, and a relation between the adsorption amount of carbon monoxide and the activation temperature was shown in FIG. 3.

As is apparent from FIG. 3, the adsorbents subjected to an activation treatment at 300° C. and 350° C. show a small adsorption amount of carbon monoxide under a low pressure. That is, the adsorbents subjected to an activation treatment at a low temperature shows low adsorption ability in a very low partial pressure range, which is important for reducing the amount of carbon monoxide in the gas to be purified to a ppb level.

As the activation temperature becomes higher, carbon monoxide adsorption ability is improved, while it shows plateau at 450° C. or higher and, in reverse, deteriorates at 600° C. or higher.

### Example 3

An influence of the regeneration temperature exerted on the adsorption ability of carbon monoxide in a gas purification method using the adsorbent for carbon monoxide of the present invention is shown below.

In the same manner as in Example 1, a commercially available Cu-ZSM5 type zeolite as a catalyst for removal of NO_{X} was activated at 500° C. for 3 hours, to obtain an adsorbent of the present invention.

Next, each adsorbent (1 g) was filled in a volumetric adsorption measuring apparatus and an absorption/desorption operation of heat-regenerating at 100° C. after allowing nitrogen containing 5 ppm of carbon monoxide to flow was carried out once, and then the adsorption amount of carbon monoxide at 25° C. was measured and an adsorption isotherm was measured.

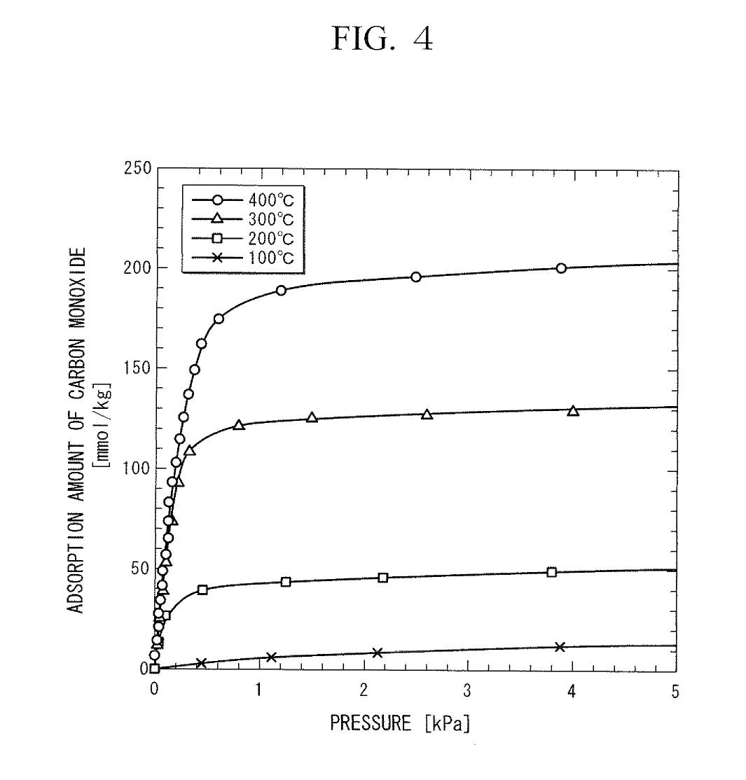

Similarly, regarding the case where the regeneration temperature is set at 200° C., 300° C. and 400° C., an adsorption isotherm was measured and an influence of the regeneration temperature exerted on the adsorption amount of carbon monoxide was examined. The adsorption isotherm at each regeneration temperature is shown in FIG. 4.

The adsorbent shows a small adsorption amount of carbon monoxide at 100° C., and particularly rapid rising of the adsorption isotherm in a very low pressure range of 0.5 Pa or less is not observed, as in the case where regeneration is carried out at 200° C. or higher. Therefore, it is considered that, according to a gas purification method using the adsorbent for carbon monoxide of the present invention, it is difficult to carry out gas purification to reduce the amount of carbon monoxide in the gas to be purified to less than a ppb level when the regeneration temperature is 100° C. The regeneration temperature is preferably 200° C. or higher.

### Example 4

In a gas purification apparatus using a temperature swing adsorption method, a test for removal of carbon monoxide in nitrogen was carried out. An adsorption column measuring 17.4 mm in inner diameter was filled with a commercially available Cu-ZSM5 type zeolite as a catalyst for removal of NO_{X} in height of 0.2 m. A carbon monoxide removal test was carried out after activating the zeolite at 500° C. while allowing nitrogen to flow

The operation conditions are as follows: an adsorption pressure: 0.6 MPa, an adsorption temperature: 25° C., and a regeneration temperature: 200° C. While allowing nitrogen containing 5 ppm of carbon monoxide to flow at a rate of 20 L/min, the concentration of carbon monoxide in purified nitrogen was measured by Process Gas Analyzer (RGA5) manufactured by Trace Analytical, Inc. disposed in a line at a gas outlet side of the adsorption column.

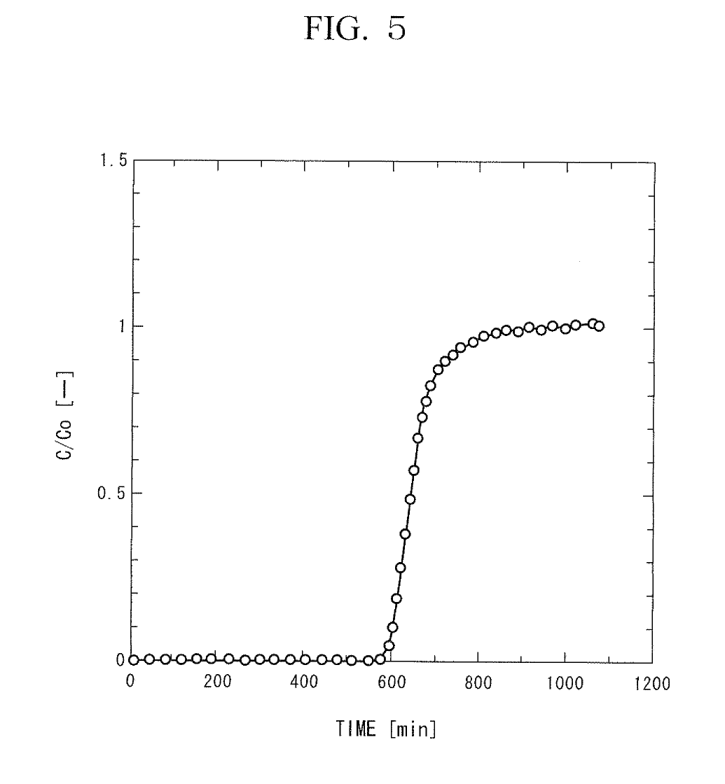

As shown in FIG. 5, the concentration of carbon monoxide was lower detection limit or less for about 10 hours. The vertical axis of FIG. 5 denotes a C/C₀ ratio where C₀ is the concentration of carbon monoxide at an inlet of a purifier and C is the concentration at an outlet, while the horizontal axis denotes a lapsed time after the onset of introducing nitrogen containing carbon monoxide into the purifier.

### Example 5

In the same manner as in Example 4, a test for removal of carbon monoxide in argon was carried out. An adsorption column measuring 17.4 mm in inner diameter was filled with a commercially available Cu-ZSM5 type zeolite as a catalyst for removal of NO_{X} in height of 0.2 m. A carbon monoxide removal test was carried out after activating the zeolite at 500° C. while allowing nitrogen to flow.

The operation conditions are as follows: an adsorption pressure: 0.6 MPa, an adsorption temperature: 25° C., and a regeneration temperature: 200° C. While allowing argon containing 5 ppm of carbon monoxide to flow at a rate of 20 L/min, the concentration of carbon monoxide in purified argon was measured by Process Gas Analyzer (RGA5) manufactured by Trace Analytical, Inc. disposed in a line at a gas outlet side of the adsorption column.

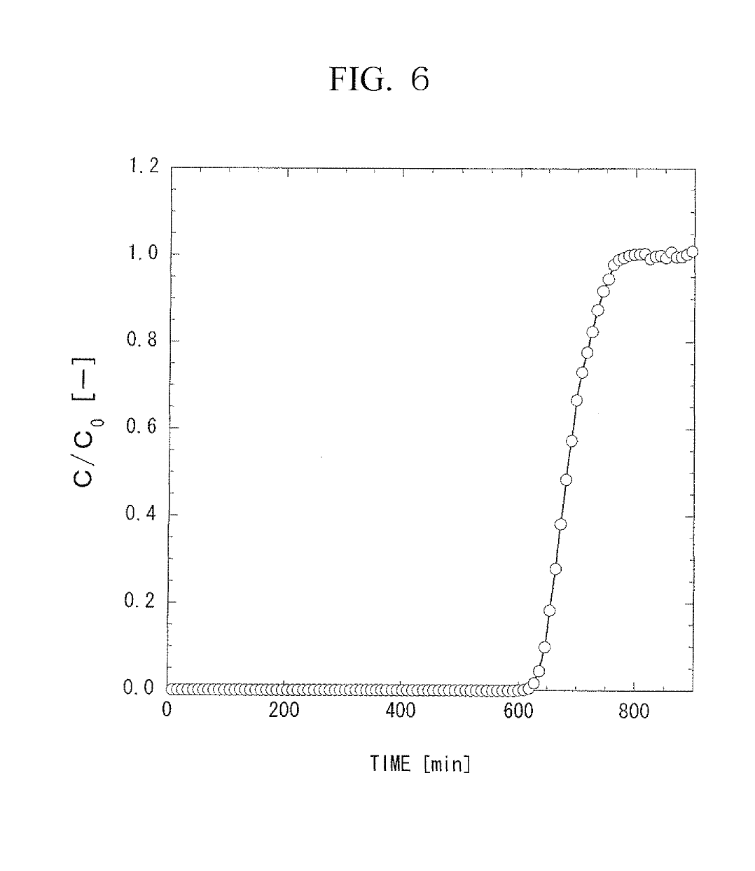

As shown in FIG. 6, the concentration of carbon monoxide was lower detection limit or less for about 10 hours.

### Comparative Example 1

As Comparative Example of Example 4, a test was carried out with respect to activation in nitrogen containing moisture. An adsorption column having an inner diameter of 17.4 mm was filled with a commercially available Cu-ZSM5 type zeolite as a catalyst for removal of NO_{X} in height of 0.2 m. After activation was carried out at 500° C. by allowing nitrogen containing saturated steam at 25° C. to flow, a carbon monoxide removal test was carried out.

Operation conditions are as follows: an adsorption pressure: 0.6 MPa, an adsorption temperature: 25° C., and a regeneration temperature: 200° C. While allowing nitrogen containing 5 ppm of carbon monoxide to flow at a rate of 20 L/min, the concentration of carbon monoxide in purified nitrogen was measured by Process Gas Analyzer (RGA5) manufactured by Trace Analytical, Inc. disposed in a line at a gas outlet side of the adsorption column.

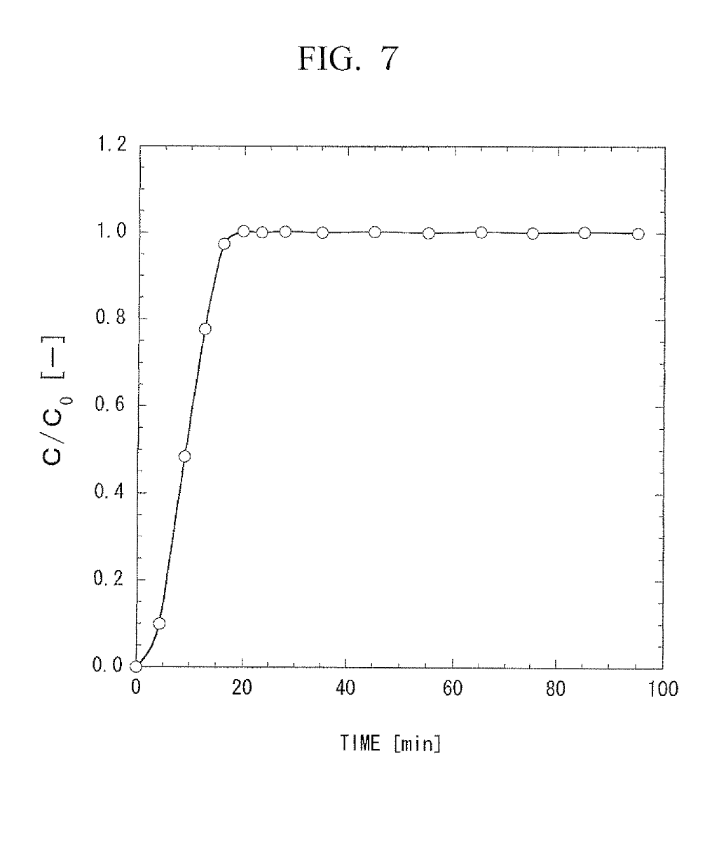

As shown in FIG. 7, breakthrough of carbon monoxide was confirmed simultaneously with the beginning of a test.

It was found that activation is preferably carried out using nitrogen containing no moisture.

### INDUSTRIAL APPLICABILITY

As described above, by using the adsorbent for carbon monoxide of the present invention, and gas purification method and gas purification apparatus each using the adsorbent for carbon monoxide, carbon monoxide can be substantially removed from a rare gas such as nitrogen, argon or the like, and thus it becomes possible to produce a ultrahigh-purity inert gas required for semiconductor industry.

1. An adsorbent for carbon monoxide obtained by activating a Cu-ZSM5 type zeolite prepared as a catalyst for removal of NOX through heating at 450 to 600° C. in an inert gas atmosphere containing no moisture.

2. A gas purification method comprising removing carbon monoxide as a trace amount of an impurity contained in a gas by a temperature swing adsorption method, wherein
the adsorbent for carbon monoxide according to claim 1 is used, and a regeneration operation of the adsorbent for carbon monoxide is carried out at 200 to 350° C.

3. A gas purification method according to claim 2, wherein the gas to be purified is high-purity nitrogen, argon, helium, neon, krypton or xenon.

4. A gas purification apparatus comprising an adsorption column filled with the adsorbents for carbon monoxide according to claim 1, and a heating device for heat regeneration of the adsorbents filled in the adsorption column at 200 to 350° C., wherein
a gas is purified by a temperature swing adsorption method.

5. A gas purification apparatus according to claim 4, wherein the heating device heats a gas to be regenerated.

6. A cryogenic air separation unit comprising the gas purification apparatus according to claim 4.
